(19) United States
(12) Patent Application Publication
(10) Pub. No.: US 2014/0083613 A1
(43) Pub. Date: Mar. 27, 2014

(54) GAS SUPPLY DEVICE FOR A VACUUM PROCESSING CHAMBER, METHOD OF GAS SUPPLYING AND SWITCHING

(71) Applicants: Songlin XU, Shanghai (CN); Tuqiang NI, Shanghai (CN); Qiang WEI, Shanghai (CN)

(72) Inventors: Songlin XU, Shanghai (CN); Tuqiang NI, Shanghai (CN); Qiang WEI, Shanghai (CN)

(21) Appl. No.: 14/030,405

(22) Filed: Sep. 18, 2013

(30) Foreign Application Priority Data
Sep. 20, 2012 (CN) 201210351005.X

(51) Int. Cl. G05D 7/06

(52) U.S. Cl. CPC G05D 7/0617
USPC 156/345.33; 137/597; 137/1

(57) ABSTRACT

The present disclosure provides a gas supply device used in vacuum processing chambers, which comprises: a first gas source and a second gas source; a first gas switch in which its input is connected to the first gas source and its output can be switchably connected to the gas inlets of two vacuum processing chambers or two processing stations in one vacuum processing chamber; a second gas switch, in which its input is connected to the second gas source and its output can be switchably connected to the gas inlets of the two vacuum processing chambers or the two processing stations; a control device for controlling the switching of the first gas switch and the second gas switch, so as to make the first gas source and the second gas source complementarily switch between two vacuum processing chambers or two processing stations in one vacuum processing chamber. The present disclosure achieves complementary switching of reactant gases in at least two vacuum processing chambers, which achieves full use of reactant gases, saving the cost and improving work efficiency.

### TECHNICAL FIELD

The present invention relates to process gas share and control used in semiconductor manufacturing process, more particularly to a gas supply device for application of rapidly switching process gas, and a method of the gas supplying and switching.

### BACKGROUND TECHNOLOGY

Bosch method, namely “Bosch” process, is a time division multiplexing (TDM) method used in etching silicon. In this process procedure, it alternatively performs deposition step and etching step. Every etching-deposition cycle constitutes a process cycle.

At present, during the rapid gas switching type process procedure, such as Bosch method and Through Silicon Via (TSV) etching, the deposition process and the etching process are continuously and alternatively performed, so different reactant gases should be supplied into process module (PM) during different process steps, i.e. to achieve the rapid switching of the process gas in the process module, the process module can be vacuum processing chambers or several processing stations in one vacuum processing chamber. In order to achieve rapid switching ON and OFF of the process gas, and to ensure that there is no processing gas supply shortage problem during the period of rapid switching of the process gas, the prior art solution is to maintain the continuous delivery of processing gas, ensuring the normal operation of the process procedure which is a type of application of rapid switching process gas.

As shown in FIG. 1 and FIG. 2, the patent with international application No. of PCT/US2003/025290 discloses a type of gas delivery device, which includes mass flow controller (MFC) 11′ and mass flow controller 13′. The inputs of the mass flow controller (MFC) 11′ and the mass flow controller (MFC) 13′ are connected to the first gas 10′ (gas A) and the second gas 12′ (gas B) respectively; the outputs of the mass flow controller 11′ are connected to inputs of chamber bypass valve 2′ and chamber inlet valve 4′ respectively; the outputs of the mass flow controller 13′ are connected to inputs of chamber inlet valve 6′ and chamber bypass valve 8′ respectively. The outputs of chamber inlet valve 4′ and chamber inlet valve 6′ are connected to process chamber 14′; the process chamber 14′ has an exhaust port 20′ which is used to discharge the reacted gas from the process chamber 14′. The outputs of the chamber bypass valve 2′ and the bypass valve 8′ are connected to the exhaust port 20′ directly. The first gas 10′ (gas A) and the second gas 12′ (gas B) are kept continuous delivery during entire process procedure.

As shown in FIG. 1, when the process chamber 14′ requires the first gas 10′ to be delivered to the chamber for process, the chamber inlet valve 4′ is opened, the chamber bypass valve 2′ is closed, the chamber inlet valve 6′ is closed and the chamber bypass valve 8′ is opened. When the first gas 10′ passes through the mass flow controller 11′ and the chamber inlet valve 4′ and flows into the process chamber 14′, the first gas 10′ is used as the reactant gas to perform process. After the process completes, the exhaust gas is discharged from the exhaust port 20′. The second gas 12′ passing through the mass flow controller 13′ and the chamber bypass valve 8′ is directly discharged from the exhaust port 20′.

As shown in FIG. 2, when the process chamber 14′ requires the second gas 12′ to be delivered into the chamber for process, the chamber inlet valve 4′ is closed, the chamber bypass valve 2′ is opened, the chamber inlet valve 6′ is opened and the chamber bypass valve 8′ is closed. When the second gas 12′ passes through the mass flow controller 13′ and the chamber inlet valve 6′ and flows into the process chamber 14′, the second gas 12′ is used as the reactant gas to perform process. After the process completes, the exhaust gas of the second gas 12′ is discharged from the exhaust port 20′. The first gas 10′ passing through the mass flow controller 11′ and the chamber bypass valve 2′ is directly discharged from the exhaust port 20′.

During the entire process procedure, according to the requirements of process, the first gas 10′ (gas A) or the second gas 12′ (gas B) is rapidly switched to enter into the process chamber 14′. The continuous delivery of the first gas 10′ and the second gas 12′ ensures that there will be no process gas supply shortage problem during the process of rapid switching and gas switching. When the first gas 10′ is introduced into the process chamber 14′, the second gas 12′ should not be closed but directly discharged from the exhaust port 20′. Likewise, when the second gas 12′ is introduced into the process chamber 14′, the first gas 10′ should not be closed, the gas A should be continuously delivered and directly discharged from the exhaust port 20′.

The disadvantage is that, to ensure normal operation of the process during entire process procedure, the process gas must be continuously delivered. There is always one type of reactant gas to be directly discharged to the exhaust without performing any process during the process operation, which wastes large amount of processing gas and increases production cost.

### SUMMARY OF THE INVENTION

The present invention provides A gas supply device for a vacuum processing chamber for alternatively providing at least two kinds of reactant gases into two vacuum processing chambers or two processing stations in one vacuum processing chamber□ which solves the problem of gas waste during the rapid gas switching type application and therefore reduce the cost.

To achieve the above purposes, the present invention provides A gas supply device for a vacuum processing chamber for alternatively providing at least two kinds of reactant gases into two vacuum processing chambers or two processing stations in one vacuum processing chamber; wherein, the gas supply device comprises: a first gas source and a second gas source providing a first gas and a second gas, respectively; a first gas switch, in which an input of the first gas switch is connected to the first gas source and an output of the first gas switch is switchably connected to gas inlets of the two vacuum processing chambers or the two processing stations respectively; a second gas switch, in which an input of the second gas switch is connected to the second gas source and an output of the second gas switch is switchably connected to the gas inlets of the two vacuum processing chambers or the two processing stations respectively; a control device for controlling the switching of the first gas switch and the second gas switch, so that when the first gas is connected to the gas inlet of one of the two vacuum processing chambers or one of the two processing stations and supplies the first gas through the gas inlet, the second gas is connected to the gas inlet of the other one of two vacuum processing chambers or the two processing stations, and supplies the second gas through the gas inlet.

Wherein the first gas is etching reactant gas and said second gas is deposition reactant gas. The first gas includes SF₆ and O₂; the second gas includes C₄F₈, C₃F₆ and N₂ .

Wherein the switching time of switching the first gas switch and the second gas switch is less than 3 seconds.

Wherein, a first mass flow controller is connected between an output of the first gas source and the input of the first gas switch; and, a second mass flow controller is connected between an output of the second gas source and the input of the second gas switch.

Wherein, the gas supply device further comprises: a first gas collection unit, in which an input of the first gas collection unit is connected to a first valve; the first valve is installed at the output of the first gas source; an output of the first gas collection unit is connected to the first gas source to gather the residual first gas and return it to the first gas source; a second gas collection unit, in which an input of second gas collection unit is connected to a second valve; the second valve is installed at the output of the second gas source; an output of the second gas collection unit is connected to the second gas source to gather the residual second gas and return it to the second gas source.

Wherein, the gas supply device further includes a gas bypass which discharges the residual first gas or the residual second gas from vacuum processing chamber.

A vacuum processing chamber, wherein, the vacuum processing chamber includes any one of said gas supply devices mentioned above.

In another embodiment of the invention a method of supplying gas to vacuum processing chamber is provided, which is used to alternatively provide at least two reactant gases for at least two vacuum processing chambers or two stations in one vacuum processing chamber, in which, the vacuum processing chamber includes any one of gas supply devices mentioned above; wherein, the gas supply and switching method include the following procedures: Controlling the first gas switch to connect the first gas source with one of the two vacuum processing chambers or one of the two processing stations, the first gas source supplying the first gas for performing a first process; controlling the second gas switch to connect the second gas source with the other one of two vacuum processing chambers or the other one of the two processing stations, the second gas source supplying the second gas for performing a second process; controlling the control device to control the rapid switching between the first gas switch and the second gas switch, so that the first gas source and the second gas source exchange the connection with the respectively connected vacuum processing chamber or station; repeating the above steps.

Wherein the processing time performed in the two vacuum processing chambers or in the two processing stations are the same or substantially the same.

Wherein the processing time performed in each of the vacuum processing chambers or each of the stations could be different; the first solution of present invention is reducing the output power of a radio-frequency power supply connected to the vacuum processing chamber or the station which has completed the process, keep supplying reactant gas to the vacuum processing chamber or the station, until the other vacuum processing chamber or the other station which has not finished the process completes the process; when the process of all the vacuum processing chambers or the stations is finished, the first gas switch and the second gas switch are controlled to switch the connection of the reactant gas sources with the vacuum processing chambers or stations, and the output power of the radio-frequency power supply connected to all the vacuum processing chambers or the stations are returned to normal output level.

When the processing time performed in each of the vacuum processing chambers or each of the stations is different□the second and third solution for the present invention are:

provided that the processing time of one of the vacuum processing chambers or stations is shorter than that of other vacuum processing chambers or stations, slow down the reaction speed of the vacuum processing chamber or the station which has shorter processing time so that the whole processing time required in all vacuum processing chambers or all stations are the same or substantially the same.

provided that the time required by the first process is longer than that of the second process, and when the second process is completed firstly, open the second valve, the second gas flows into the second gas collection unit and returns to the second gas source via the second gas collection; when the first process and the second process are both completed, close the second valve, and switch rapidly the first gas switch and the second gas switch so that the connection of the first gas source or the second gas source between the two vacuum processing chambers or the two processing stations is exchanged. The present invention provides a gas supply device for a vacuum processing chamber, and a method of gas supply and gas switching. In comparison with the current gas share and delivery technology which is used in the process of rapid gas switching type, the advantages are as follows: the semiconductor processing equipment which is disclosed in the present invention, is equipped with multi-way reactant gas sources and includes multiple vacuum processing chambers or multiple processing stations in one vacuum processing chamber; every reactant gas source is connected to all or some of the vacuum processing chambers or the processing stations in one vacuum processing chamber via the pipelines. The pipelines are equipped with gas switches, and the gas switches control the rapid switching of the connection of the reactant gas source with the vacuum processing chambers or the processing stations in one vacuum processing chamber according to the process requirements. When the reactant gas introduced into vacuum processing chambers or the processing stations in one vacuum processing chamber is switched, the reactant gas which is not needed currently can be introduced to other vacuum processing chambers or other processing stations in one vacuum processing chamber which need such reactant gas for process operation according to process requirements. By complementing and switching reactant gas source connected to the vacuum processing chambers or the processing stations in one vacuum processing chamber, achieve the full use of the delivered reactant gases, rather than directly discharge the temporarily unused reactant gases, saving the cost and improving the work efficiency.

### BRIEF DESCRIPTION OF THE DRAWINGS

FIG. 1 is an operation schematic drawing of a prior art gas supply device;

FIG. 2 is an operation schematic drawing of a prior art gas supply device;

FIG. 3 is the structure schematic drawing of a gas supply device for a vacuum processing chamber according to the first embodiment of the present invention;

FIG. 4 is the structure schematic drawing of a gas supply device for a vacuum processing chamber according to the second embodiment of the present invention;

FIG. 5 is the connection schematic drawing of the gas supply device for a vacuum processing chamber with the two stations in one vacuum processing chamber;

FIG. 6 is the sequence diagram for a gas supply and switching method for a vacuum processing chamber.

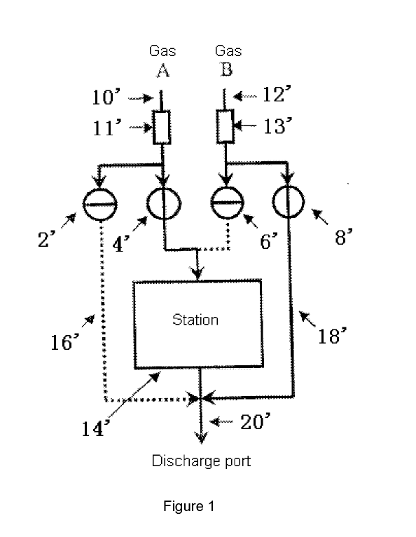

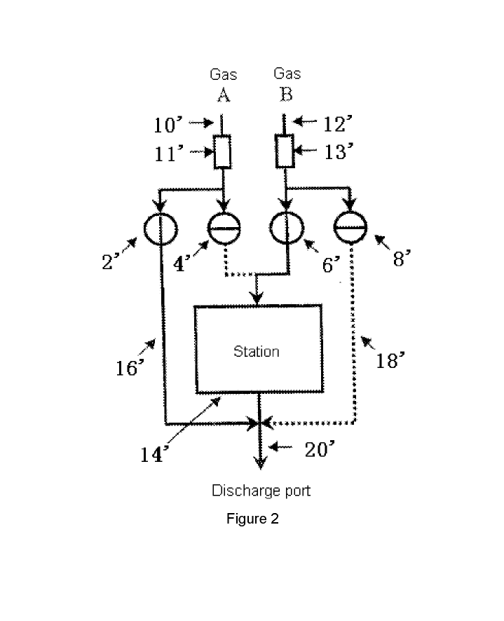

### DETAILED DESCRIPTION OF THE EMBODIMENTS

The description of the embodiments of the present invention will be further described in combination with the following attached drawing.

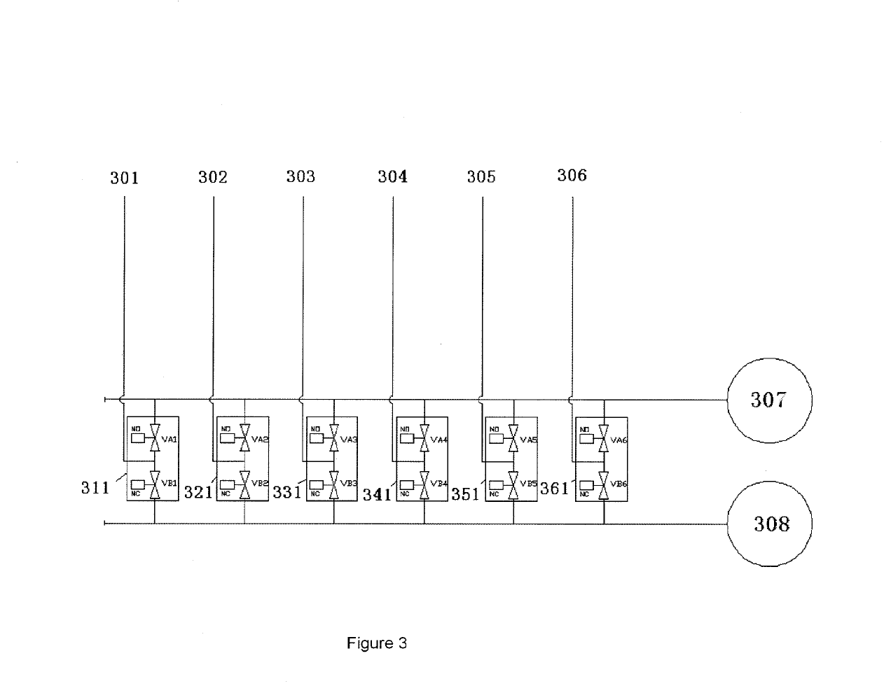

FIG. 3 shows a first embodiment of a gas supply device for a vacuum processing chamber of the present invention. In this embodiment, the gas supply device is used in semiconductor equipment for the application of TSV process. TSV process requires rapid switching between etching step and deposition step.

The gas supply device includes six gas switches and six reactant gas sources. The outputs of the gas supply device are connected to two vacuum processing chambers or two processing stations in one vacuum processing chamber.

In this embodiment, the outputs of gas supply device are connected to two vacuum processing chambers, which are the first vacuum processing chamber 307 and the second vacuum processing chamber 308.

The six reactant gas sources are the first reactant gas source 301, the second reactant gas source 302, the third reactant gas source 303, the fourth reactant gas source 304, the fifth reactant gas source 305 and the sixth reactant gas source 306.

The outputs of the six reactant gas sources can be set as six reactant gas sources to deliver six different reactant gases, or can be set to deliver the same reactant gas by some reactant gas sources. The six reactant gas sources output at least two different reactant gases.

In this embodiment, the six reactant gas sources output six different reactant gases respectively, which can be divided into two groups: etching reactant gas and deposition reactant gas according to the process ratio. The first reactant gas source 301, the second reactant gas source 302 and the third reactant gas source 303 are in one group. The first reactant gas source 301, the second reactant gas source 302 and the third reactant gas source 303 outputs three different gases, respectively, such as SF₆ ,O₂ etc. The output volume of reactant gases from the first reactant gas source 301, the second reactant gas source 302 and the third reactant gas source 303 should be set as required, and then the output reactant gases are mixed with predetermined ratio so as to form etching reactant gas for etching process. The flow rate of etching reactant gas in TSV process is generally set at 2000 sccm.

The fourth reactant gas source 304, the fifth reactant gas source 305 and the sixth reactant gas source 306 are in one group. The fourth reactant gas source 304, the fifth reactant gas source 305 and the sixth reactant gas source 306 outputs three different gases, respectively, such as C₄F₈, C₃F₆ and N₂ etc. The output volume of reactant gases from the fourth reactant gas source 304, the fifth reactant gas source 305 and the sixth reactant gas source 306 should be set as required, and then the output reactant gases are mixed with predetermined ratio so as to form deposition reactant gas for deposition process. The flow rate of deposition reactant gas in TSV process is generally set at 1000 sccm.

In TSV process, the above mentioned six reactant gas sources should be kept supplying reactant gases continuously to ensure rapid switching among above reactant gases.

In this embodiment, six gas switches are the first gas switch 311, the second gas switch 321, the third gas switch 331, the fourth gas switch 341, the fifth gas switch 351 and the sixth gas switch 361. These six gas switches are three-way valve; each gas switch has one input and two outputs. The three-way valve can be power-driven three-way valve or pneumatic three-way valve, so that the trigging and switching time of this gas switch is less than 3 seconds.

One input of each gas switch is connected to one reactant gas source via the pipeline, in which, the input of the first gas supply 311 is connected to the first reactant gas source 301 via gas supply pipeline; the second gas supply 321 is connected to the second reactant gas source 302 via gas supply pipeline; the third gas supply 331 is connected to the third reactant gas source 303 via gas supply pipeline; the fourth gas supply 341 is connected to the fourth reactant gas source 304 via gas supply pipeline; the fifth gas supply 351 is connected to the fifth reactant gas source 305 via gas supply pipeline; and the six gas supply 361 is connected to the sixth reactant gas source 306 via gas supply pipeline.

A mass flow controller (MFC) is connected between each input of the six gas switches and the respective connected reactant gas sources. The input of the MFC is connected to reactant gas source via the pipeline; its output is connected to gas supply pipeline and then connected to gas switch via gas supply pipeline.

A rapid switch is set between the input and two outputs of each gas switch. These two rapid switches can receive the same control signal which controls the connection and disconnection of two rapid switches with complementary relationship. The switching time of the complemented rapid switches should be less than 2 seconds. The details are described as follows.

Rapid switch VA1 and Rapid switch VB1 are equipped respectively between the input and two outputs of the first gas switch 311. The rapid switch VA1 and the rapid switch VB1 control the connection and disconnection between the input and two outputs of the first gas switch 11. The rapid switch VA1 and the rapid switch VB1 can receive the same control signal to connect and disconnect with complementary relationship. When the rapid switch VA1 is connected, the rapid switch VB1 is disconnected; when the rapid switch VB1 is connected, the rapid switch VA1 is disconnected.

Rapid switch VA2 and Rapid switch VB2 are equipped respectively between the input and two outputs of the second gas switch 321 separately. The rapid switch VA2 and the rapid switch VB2 control the connection and disconnection between the input and two outputs of the second gas switch 21. The rapid switch VA2 and the rapid switch VB2 can receive the same control signal to connect and disconnect with complementary relationship. When the rapid switch VA2 is connected, the rapid switch VB2 is disconnected; when the rapid switch VB2 is connected, the rapid switch VA2 is disconnected.

Rapid switch VA3 and Rapid switch VB3 are equipped respectively between the input and two outputs of the third gas switch 331. The rapid switch VA3 and the rapid switch VB3 control the connection and disconnection between the input and two outputs of the third gas switch 31. The rapid switch VA3 and the rapid switch VB3 can receive the same control signal to connect and disconnect with complementary relationship. When the rapid switch VA3 is connected, the rapid switch VB3 is disconnected; when the rapid switch VB3 is connected, the rapid switch VA3 is disconnected.

Rapid switch VA4 and Rapid switch VB4 are equipped respectively between the input and two outputs of the fourth gas switch 341. The rapid switch VA4 and the rapid switch VB4 control the connection and disconnection between the input and two outputs of the fourth gas switch 41. The rapid switch VA4 and the rapid switch VB4 can receive the same control signal to connect and disconnect with complementary relationship. When the rapid switch VA4 is connected, the rapid switch VB4 is disconnected; when the rapid switch VB4 is connected, the rapid switch VA4 is disconnected.

Rapid switch VA5 and Rapid switch VB5 are equipped respectively between the input and two outputs of the fifth gas switch 351. The rapid switch VA5 and the rapid switch VB5 control the connection and disconnection between the input and two outputs of the fifth gas switch 51. The rapid switch VA5 and the rapid switch VB5 can receive the same control signal to connect and disconnect with complementary relationship. When the rapid switch VA5 is connected, the rapid switch VB5 is disconnected; when the rapid switch VB5 is connected, the rapid switch VA5 is disconnected.

Rapid switch VA5 and Rapid switch VB5 are equipped respectively between the input and two outputs of the sixth gas switch 361. The rapid switch VA6 and the rapid switch VB6 control the connection and disconnection between the input and two outputs of the sixth gas switch 61. The rapid switch VA6 and the rapid switch VB6 can receive the same control signal to connect and disconnect with complementary relationship. When the rapid switch VA6 is connected, the rapid switch VB6 is disconnected; when the rapid switch VB6 is connected, the rapid switch VA6 is disconnected.

Specifically, when the rapid switch VA1 is connected and the rapid switch VB1 is disconnected, the gas is introduced into the first vacuum processing chamber 307; when the rapid switch VB1 is connected and the rapid switch VA1 is disconnected, the gas is introduced into the second vacuum processing chamber 308.

In this embodiment, the outputs of the gas supply device are connected to two vacuum processing chambers, which are the first vacuum processing chamber 307 and the second vacuum processing chamber 308.

Two outputs of each gas switch 311 to 361 are connected respectively to two vacuum processing chambers 307 and 308 via gas supply pipelines.

According to process requirements, each of the above mentioned six gas switches 311 to 361 controls respectively the rapid switching of the connection of the reactant gas sources with the two processing chambers 307 and 308 which are connected to the corresponding gas supply pipelines.

In this embodiment, the method of gas supplying and switching of the gas supply device includes the following procedures.

According to TSV process requirements, the required reactant gases for each vacuum processing chamber are determined. For example, in the current stage of the process, the first vacuum processing chamber 307 needs to perform etching process and the second vacuum processing chamber 308 needs to perform deposition process. Under the current stage of the process, the etching reactant gas which comprises SF₆, O_{2□}Ar etc. with required gas mixture ratio needs to be introduced into the first vacuum processing chamber 307 at the flow rate of 2000 sccm; the deposition reactant gas which comprises C₄F₈, C₃F₆, and N₂ etc. with required gas mixture ratio needs to be introduced into the second vacuum processing chamber 308 at the flow rate of 1000 sccm.

Each gas switch corresponding to each reactant gas source controls the gas path connection between the reactant gas source and the vacuum processing chamber which needs this type of reactant gas. Meanwhile, each gas switch disconnects the gas path between the corresponding reactant gas source and the vacuum processing chamber which does not need this type of reactant gas, and introduces this type of unneeded reactant gas into another vacuum processing chamber, so that two processing chambers can perform deposition/etching processes alternatively.

The control signals are transmitted respectively to the first gas switch 311, the second gas switch 321, the third gas switch 331, the fourth gas switch 341, the fifth gas switch 351 and the sixth gas switch 361.

The control signal triggers the first gas switch 311 to open the rapid switch VA1 and to close the rapid switch VB1, so that the etching reactant gas from the first reactant gas source 301 flows into the first vacuum processing chamber 307. The control signal triggers the second gas switch 321 to open the rapid switch VA2 and to close the rapid switch VB2, so that the etching reactant gas from the second reactant gas source 302 flows into the first vacuum processing chamber 307. The control signal triggers the third gas switch 331 to open the rapid switch VA3 and to close the rapid switch VB3, so that the etching reactant gas from the third reactant gas source 303 flows into the first vacuum processing chamber 307. The above mentioned first gas switch 311, the second gas switch 321 and the third gas switch 331 control respectively the etching reactant gas delivered from the first reactant gas source 301, the second reactant gas source 302 and the third reactant gas source 303 to flow into the first vacuum processing chamber 307 at a certain mixture ratio. The etching process is operated in the first vacuum processing chamber 307.

Meanwhile, the control signal triggers the fourth gas switch 341 to close the rapid switch VA4 and to open the rapid switch VB4, so that the deposition reactant gas from the fourth reactant gas source 304 flows into the second vacuum processing chamber 308. The control signal triggers the fifth gas switch 351 to close the rapid switch VA5 and to open the rapid switch VB5, so that the deposition reactant gas from the fifth reactant gas source 305 flows into the second vacuum processing chamber 308. The control signal triggers the sixth gas switch 361 to close the rapid switch VA6 and open the rapid switch VB6, so that the deposition reactant gas from the sixth reactant gas source 306 flows into the second vacuum processing chamber 308. The above mentioned fourth gas switch 341, the fifth gas switch 351 and the sixth gas switch 361 control respectively the deposition reactant gas delivered from the fourth reactant gas source 304, the fifth reactant gas source 305 and the sixth reactant gas source 306 to flow into the second vacuum processing chamber 308 at a certain mixture ratio. The deposition process is operated in the second vacuum processing chamber 308.

When the etching process in above mentioned first vacuum processing chamber 307 and the deposition process in above mentioned second vacuum processing chamber 308 have been operated in less than 3 seconds, the first vacuum processing chamber 307 and the second vacuum processing chamber 308 will transfer to the next process step, respectively. That is, the first vacuum processing chamber 307 is switched to deposition process and the deposition reactant gas should be introduced; while the second vacuum processing chamber 308 is switched to etching process and the etching reactant gas should be introduced.

According to above process requirements, each gas switch rapidly switches the gas flow path between the corresponding reactant gas source and the respective vacuum processing chamber. Each gas switch disconnects the gas flow path between the corresponding reactant gas source and the currently connected vacuum processing chamber, and connects the gas flow path between reactant gas source and the vacuum processing chambers which is needed this reaction process in next process stage.

The control signal triggers the first gas switch 311 to open the rapid switch VB1 and to close the rapid switch VA1, so that the etching reactant gas from the first reactant gas source 301 flows into the second vacuum processing chamber 308. The control signal triggers the second gas switch 321 to open the rapid switch VB2 and to close the rapid switch VA2, so that the etching reactant gas from the second reactant gas source 302 flows into the second vacuum processing chamber 308. The control signal triggers the third gas switch 331 to open the rapid switch VB3 and to close the rapid switch VA3, so that the etching reactant gas from the third reactant gas source 303 flows into the second vacuum processing chamber 308. The above mentioned first gas switch 311, the second gas switch 321 and the third gas switch 331 control respectively the etching reactant gas delivered from the first reactant gas source 301, the second reactant gas source 302 and the third reactant gas source 303 to flow into the second vacuum processing chamber 308 at a certain mixture ratio. The etching process is performed in the second vacuum processing chamber 308.

Meanwhile, the control signal triggers the fourth gas switch 341 to close the rapid switch VB4 and to open the rapid switch VA4, so that the deposition reactant gas from the fourth reactant gas source 304 flows into the first vacuum processing chamber 307. The control signal triggers the fifth gas switch 351 to close the rapid switch VB5 and to open the rapid switch VA5, so that the deposition reactant gas from the fifth reactant gas source 305 flows into the first vacuum processing chamber 307. The control signal triggers the sixth gas switch 361 to close the rapid switch VB6 and to open the rapid switch VA6, so that the deposition reactant gas from the sixth reactant gas source 306 flows into the first vacuum processing chamber 307. The above mentioned fourth gas switch 341, the fifth gas switch 351 and the sixth gas switch 361 control respectively the deposition reactant gas delivered from the fourth reactant gas source 304, the fifth reactant gas source 305 and the sixth reactant gas source 306 to flow into the first vacuum processing chamber 307 at a certain mixture ratio. The deposition process is performed in the first vacuum processing chamber 307.

When the deposition process in above mentioned first vacuum processing chamber 307 and the etching process in above mentioned second vacuum processing chamber 308 have been operated time less than 3 seconds, the first gas switch 311, the second gas switch 321, the third gas switch 331, the fourth gas switch 341, the fifth gas switch 351 and the sixth gas switch 361 are controlled again to switch, so that the deposition reactant gases delivered from the fourth reactant gas source 304, the fifth reactant gas source 305 and the sixth reactant gas source 306 flow into the second vacuum processing chamber 308; while the etching reactant gases delivered from the first reactant gas source 301, the second reactant gas source 302 and the third reactant gas source 303 flow into the first vacuum processing chamber 307. The deposition and etching processes are performed respectively in the second vacuum processing chamber 308 and the first vacuum processing chamber 307 correspondingly.

The above procedures should be circulated, i.e. according to the process requirements, the gas supply device will control the rapid switching of processing gases introduced into the vacuum processing chambers so as to complete TSV process.

When the gas supply device of the present invention is used for gas sharing and delivery, to make sure the semiconductor processing processes in all vacuum processing chambers are normally operated, the required time of the two type of processes in all vacuum processing chambers is identical or substantially identical.

In this embodiment, the etching process time and deposition process time for rapid switching in TSV process are identical or substantially identical.

In the TSV process, if the etching process time and the deposition process time in the vacuum processing chambers are different, that is, when the process in one vacuum processing chamber is finished, but the process in another vacuum processing chamber is not finished, it will lead to that gas switching between two chambers can not be performed normally. However, the reactant gas sources must be supplied to the processing chambers continuously, which will lead to that the process in the vacuum processing chamber which has been finished will be excessively proceeded.

The following methods can be adopted to solve above mentioned problems.

If the process step time in a first vacuum processing chamber is shorter than that in a second vacuum processing chamber, and the first vacuum processing chamber will complete its current process step first, reduce the output power of radio-frequency power supply connected to the first vacuum processing chamber at the time when the current process step in the first vacuum processing chamber is finished or will be finished soon. The reaction speed in the first vacuum processing chamber will be decreased. Keep reducing the output power of radio-frequency power supply applied to the first vacuum processing chamber until the second vacuum processing chamber which has not finished its current process step completes its current process step.

When current process steps in the two vacuum processing chambers are finished, each gas switch re-controls to switch the reactant gas source connected to the corresponding vacuum processing chamber, and to recover the output power of radio-frequency power supply connected to the first vacuum processing chambers for performing the next process.

Or the following methods can be adopted to solve above mentioned problems.

If the process step time required in different vacuum processing chambers are different, slow down the reaction speed of those vacuum processing chambers which require shorter process step time, so that the process step time in each vacuum processing chamber is identical or substantially identical.

The reduction of process reaction speed can be achieved by: changing the temperature in vacuum processing chambers, changing the input power of radio-frequency power supply connected to vacuum processing chambers etc.

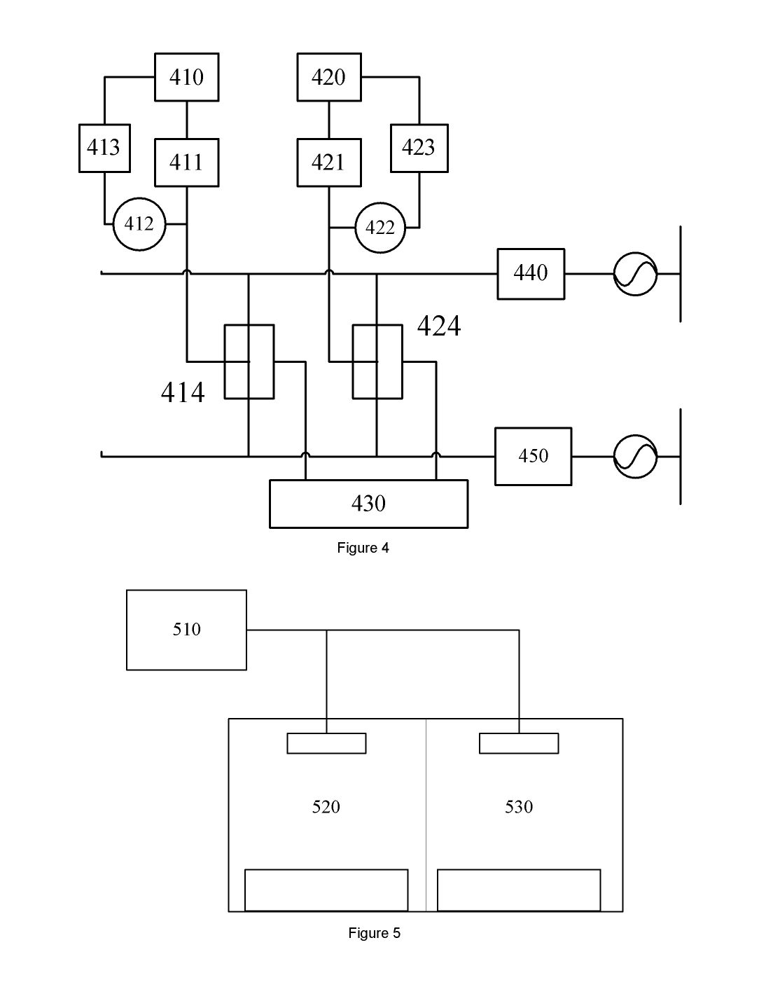

FIG. 4 shows a second embodiment of a gas supply device for a vacuum processing chamber.

The gas supply device supplies alternatively two types of reactant gases into two vacuum processing chambers. The two types of reactant gases are etching reactant gas and deposition reactant gas, respectively.

In this embodiment, the gas supply device is used to provide alternatively two types of reactant gases into two vacuum processing chambers, which are etching reactant gas and deposition reactant gas, respectively.

It should be noted that, the present invention is not limited to the above description. The gas supply device of the present invention can also be applied to provide reactant gases to two processing stations in one vacuum processing chamber. In addition, the gas supply device provides at least two types of reactant gases to at least two vacuum processing chambers or two processing stations in one vacuum processing chamber. However, the technicians in this field should understand that, the present invention is also applicable for supplying alternatively multiple reactant gases into multiple vacuum processing chambers or processing stations.

As shown in FIG. 5, the gas supply device 510 is used to supply alternatively etching reactant gas or deposition gas to two processing stations into one vacuum processing chamber, i.e. the first station 520 and the second station 530.

The gas supply device includes the first gas supply 410, the second gas supply 420, the first gas switch 414, the second gas switch 424, the control device 430, the first mass flow controller 411, the second mass flow controller 421, the first valve 412, the second valve 422, the first gas collection unit 413 and the second gas collection unit 423.

The first gas source 410 and the second gas source 420 output the first gas and the second gas respectively, in which the first gas is etching reactant gas and the second gas is deposition reactant gas. Etching reactant gas includes SF₆ and O₂ which are configured in line with process requirements. The deposition reactant gas includes C₄F₈, C₃F₆ and N₂ which are configured in line with process requirements. To achieve the rapid switching of reactant gases in vacuum processing chambers, the first gas source 410 and the second gas source 420 should continuously supply reactant gases.

The input of the first gas switch 414 is connected to the first gas source 410; the output of the first gas switch 414 is switchably connected to the gas inlets of the first vacuum processing chamber 440 and the second vacuum processing chamber 450.

The input of the second gas switch 424 is connected to the second gas source 420; the output of the second gas switch 424 is switchably connected to the gas inlets of the first vacuum processing chamber 440 and the second vacuum processing chamber 450.

The control device 430 is used to control the switching of the first gas switch 414 and the second gas switch 424 to realize that, when the first gas source 410 is connected to one of the gas inlets of the first vacuum processing chamber 440 and the second vacuum processing chamber 450 and thereby supplies etching reactant gas into the chamber, the second gas source 420 is connected to the other gas inlet of the first vacuum processing chamber 440 and the second vacuum processing chamber 450 and thereby supplies deposition reactant gas through this gas inlet. The range of the switching time of the first gas switch 414 and the second gas switch 424 is less than 3 seconds.

The first mass flow controller (MFC) 411 is installed between the output of the first gas source 410 and the input of the first gas switch 414. The second mass flow controller 421 is installed between the output of the second gas source 420 and the input of the second gas switch 424. The mass flow controller 411 is used to control the gas flow from the first gas source 410 and the second gas source 420.

Since the processing speed in different vacuum processing chambers or in different processing stations in one vacuum processing chamber is not completely identical or the same, the gas switching between the two vacuum processing chambers or between the two processing stations can not be conducted together until the vacuum processing chamber or the processing station which will finish its process later completes its process. During that period, the vacuum processing chamber or the processing station which will finish its process first or earlier must wait for the completion of the process in the other vacuum processing chamber or the other station. However, during that period, the processing gases are continuously supplied. Therefore, this present invention sets up gas collection units to collect the processing gas in the vacuum processing chamber or the station which finishes the processing first for recycle using.

A bypass is set on the pipeline between the first mass flow controller 411 and the first gas switch 414, which is connected to the input of the first gas collection unit 413. The output of the first gas collection unit 413 is connected to the first gas source 410. The first valve 412 is set in front of the input of the first gas collection unit 413; the control terminal of the first valve 412 is connected to the control device 430; the control device 430 controls the connection and disconnection of the first valve 412. Provided that the first vacuum processing chamber 440 finishes the etching process firstly, while the second vacuum processing chamber 450 is proceeding with deposition process, the first vacuum processing chamber 440 can't transfer to next process step and must wait until the second vacuum processing chamber 450 finishes the process. However, during this period, the first gas source 410 continuously outputs the etching reactant gas. When the etching reactant gas introduced to the vacuum processing chamber exceeds the gas volume for etching process in the vacuum processing chamber, the first valve 412 is opened to introduce the residual etching reactant gas into the first gas collection unit 413 and to return it to the first gas source 410 via the first gas collection unit 413.

Similarly, a bypass is set on the pipeline between the second mass flow controller 421 and the second gas switch 424, which is connected to the input of the second gas collection unit 423. The output of the second gas collection unit 423 is connected to the second gas source 420. The control terminal of the second valve 422 is set in front of the input of the second gas collection unit 423; the second valve 422 is connected to the control device 430; the control device 430 controls the connection and disconnection of the second valve 422. Provided that the second vacuum processing chamber 450 firstly finishes the deposition process, while the first vacuum processing chamber 440 is proceeding with etching process, the second vacuum processing chamber 450 can't transfer to next process step and must wait until the first vacuum processing chamber 440 finishes the process. However, during this period, the second gas source 420 outputs the deposition reactant gas continuously. When the deposition reactant gas introduced to vacuum processing chamber exceeds the gas volume for deposition process in the vacuum processing chamber, the second valve 422 is opened to introduce the residual deposition reactant gas into the second gas collection unit 423 and to return it to the second gas source 420 via the second gas collection unit 423.

In another embodiment of the gas supply device presented in the present invention, the gas supply device also includes a gas bypass. The gas bypass is connected to the outputs of the first vacuum processing chamber 440 and the second vacuum processing chamber 450 respectively, which is used to discharge the residual first gas and the second gas from the first vacuum processing chamber 440 or the second vacuum processing chamber 450.

In the second embodiment, the present invention also provides a method of gas supplying and switching for vacuum processing chambers, which is used to provides alternatively two reactant gases into two vacuum processing chambers 440 and 450 or two processing stations 520 and 530 in one vacuum processing chamber, i.e., the etching reactant gas from the first gas source 410 and the deposition reactant gas from the second gas source 420.

The vacuum processing chamber also includes the gas supply device presented in above mentioned second embodiment.

The method of gas supplying and switching is explained as following:

The processes in each vacuum processing chamber or in each station in one vacuum processing chamber is rapidly switched between etching process and deposition process. Etching reactant gas is introduced into the vacuum processing chamber or into the processing station when performing etching process; deposition reactant gas is introduced into the vacuum processing chamber or the processing station when performing deposition process.

When one vacuum processing chamber or one processing station in one vacuum processing chamber is operating etching process, the other vacuum processing chamber or another processing station in one vacuum processing chamber is operating deposition process; vice versa.

When etching process is to be operated in either the first vacuum processing chamber 440 or the second vacuum processing chamber 450, or the first processing station 520 or the second processing station 530 in one vacuum processing chamber, the control device 430 controls the first gas switch 414 to connect the first gas source 410 with the gas inlet of the vacuum processing chamber or the processing station which will run the etching process. Meanwhile, the second gas switch 424 controls the disconnection of the second gas source 420 with the vacuum processing chamber or the processing station.

When deposition process is to be operated in either the first vacuum processing chamber 440 or the second vacuum processing chamber 450, or the first processing station 520 or the second processing station 530 in one vacuum processing chamber, the control device 430 controls the second gas switch 424 to connect the second gas source 420 to the gas inlet of the vacuum processing chamber or the processing station which will run the deposition process. Meanwhile, the first gas switch 414 controls the disconnection of the first gas source 410 with the vacuum processing chamber or the processing station.

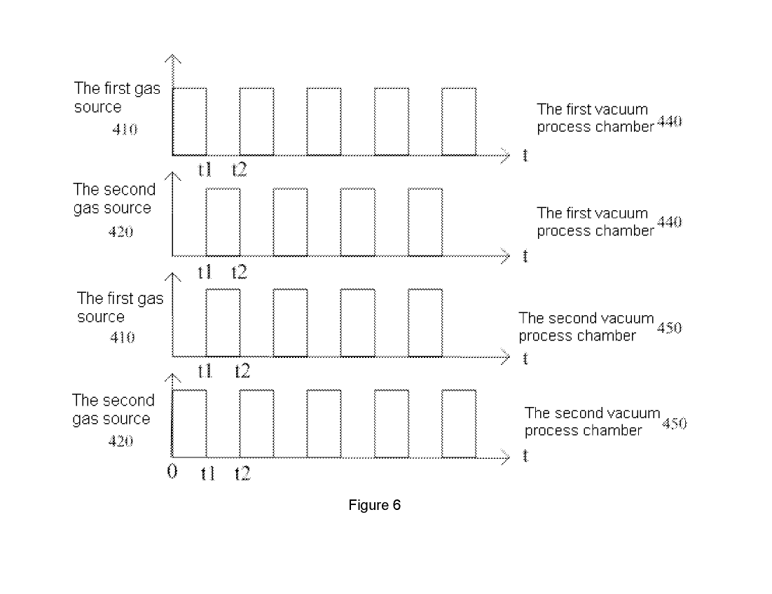

As shown in FIG. 6, provided that the etching process step time and the deposition process step time are identical or substantially identical in all vacuum processing chamber or in all processing stations in a vacuum processing chamber, the method of gas supplying and switching includes the following procedures.

Take the etching reactant gas from the first gas source 410 flowing firstly into the first vacuum processing chamber 440 as an embodiment.

At time t0, the control device 430 controls the first gas switch 414 so that the first gas source 410 is connected to the first vacuum processing chamber 440, and the first gas source 410 is disconnected from the second vacuum processing chamber 450. Meanwhile, the control device 430 controls the second gas switch 424 so that the second gas source 420 is connected to the second vacuum processing chamber 450, and the second gas source 420 is disconnected from the first vacuum processing chamber 440.

The first gas source 410 outputs the etching reactant gas to the first vacuum processing chamber 440 to operate etching process. Meanwhile, the second gas source 420 outputs the deposition reactant gas to the second vacuum processing chamber 450 to conduct deposition process.

According to the process requirements of rapid switching type process (such as, TSV or Bosch method), when the process in the first vacuum processing chamber 440 and the process in the second vacuum processing chamber 450 has run a process time t1 of less than 3 seconds, the control device 430 controls the first gas switch 414 and the second gas switch 424 to realize gas supply switching.

At time t1, the control device 430 controls the switching of the first gas switch 414 so that the first gas source 410 is connected to the second vacuum processing chamber 450, while the first gas source 410 is disconnected from the first vacuum processing chamber 440. Meanwhile, the control device 430 controls the switching of the second gas switch 424 so that the second gas source 420 is connected to the first vacuum processing chamber 440, while the second gas source 420 is disconnected from the second vacuum processing chamber 450.

The second gas source 420 outputs the deposition reactant gas to the first vacuum processing chamber 440 to conduct deposition process. Meanwhile, the first gas source 410 outputs etching reactant gas to the second vacuum processing chamber 450 to conduct etching process.

According to the process requirements of rapid switching type process (such as, TSV or Bosch method), when the process in the first vacuum processing chamber 440 and the process in the second vacuum processing chamber 450 has run a process time t2-t1 of less than 3 seconds, the control device 430 controls the first gas switch 414 and the second gas switch 424 to realize gas supply switching.

At time t2, the control device 430 controls the switching of the first gas switch 414 so that the first gas source 410 is connected to the first vacuum processing chamber 440, while the first gas source 410 is disconnected from the second vacuum processing chamber 450. Meanwhile, the control device 430 controls the switching of the second gas switch 424 so that the second gas source 420 is connected to the second vacuum processing chamber 450, while the second gas source 420 is disconnected from the first vacuum processing chamber 440.

The first gas source 410 outputs the etching reactant gas to the first vacuum processing chamber 440 to conduct etching process. Meanwhile, the second gas source 420 outputs the deposition reactant gas to the second vacuum processing chamber 450 to conduct deposition process.

The above processes should be circulated in which the method of gas supplying and switching achieves the complementary gas supply and switching between two vacuum processing chambers or two processing stations in one vacuum processing chamber.

In the second embodiment, provided that the etching process time and the deposition process time in two vacuum processing chambers or in two processing stations in one vacuum processing chamber are different, and the following four methods can be adopted:

1. If etching process time is more than deposition process time: when the deposition process in a vacuum processing chamber or in a processing station of one vacuum processing chamber is finished firstly, reduce the output power of the radio-frequency power supply connected to the vacuum processing chamber or the processing station which has finished the deposition process, so that the reaction speed in the vacuum processing chamber or in the station is reduced, until the other vacuum processing chamber or the other processing station in one vacuum processing chamber which has not finished the etching process completes its etching process.

When the current process of the etching process from the vacuum processing chamber or the processing station in one vacuum processing chamber is finished, the output power of the radio-frequency power supply connected to all vacuum processing chambers or the processing stations in one vacuum processing chamber should be recovered. The control device 430 controls the first gas switch 414 and the second gas switch 424 to switchably connect the reactant gas sources with the two vacuum processing chambers or the two processing stations in one vacuum processing chamber.

If the deposition process time is more than etching process time, the operation follows above procedures in a similar way.

2. If the etching process time is more than deposition process time: when the deposition process is operated in the vacuum processing chamber or the processing station in one vacuum processing chamber, the overall reaction speed in vacuum processing chamber or the processing station in one vacuum processing chamber should be reduced to slow down the deposition process time, so that the deposition process time and etching process time in vacuum processing chambers and the processing stations in one vacuum processing chamber are identical or substantially identical.

If the deposition process time is more than etching process time, the operation follows above procedures in a similar way.

3. If the etching process time is more than deposition process time: when the deposition process is finished firstly, the second valve 422 should be open and the deposition reactant gas is introduced to the second gas collection unit 423 and returns to the second gas source 420 via the second gas collection unit 423, until the current etching process and deposition process are both finished; the second valve 422 should be closed; the control device 430 controls the first gas switch 414 and the second gas switch 424 to rapidly switch the vacuum processing chambers or the processing stations in one vacuum processing chamber connected to the supplementary first gas source 410 and the second gas source 420.

If the deposition process time is more than etching process time: when the etching process is finished firstly, the first valve 412 should be open and the deposition reactant gas is introduced to the first gas collection unit 413 and returns to the first gas source 410 via the first gas collection unit 413, until the current etching process and deposition process are both finished; the first valve 412 should be closed; the control device 430 controls the second gas switch 424 and the first gas switch 414 to rapidly and complementarily switch the connection of the first gas source 410 and the second gas source 420 with the connected vacuum processing chamber or the processing station in one vacuum processing chamber.

4. If the etching process time is more than deposition process: when the deposition process is finished firstly, the residual deposition reactant gas is discharged from the vacuum processing chamber or the processing station in one vacuum processing chamber which is conducting deposition process via the gas bypass. When the current etching process and deposition process are both finished, the gas discharging should be stopped; the control device 430 controls the second gas switch 424 and the first gas switch 414 to rapidly switch the connection of the first gas source 410 and the second gas source 420 with the connected vacuum processing chamber or the processing station in one vacuum processing chamber.

If the deposition process time is more than etching process: when the etching process is finished firstly, the residual etching reactant gas is discharged from the vacuum processing chamber or the processing station in one vacuum processing chamber which is conducting etching process via the gas bypass. When the current etching process and deposition process are both finished, stop the gas discharging; the control device 430 controls the second gas switch 424 and the first gas switch 414 to rapidly switch the connection of the first gas source 410 and the second gas source 420 with the connected vacuum processing chamber or the processing station in one vacuum processing chamber.

Even though the present invention contents have been introduced in detail through above preferred embodiments, the above description should not be considered as the limitation to the present invention. After the technicians in this field read above contents, many revisions and replacements based on the present invention are obviously visible. Therefore, the present invention protection scope should be determined by the attached claims.

1. A gas supply device for a vacuum processing chamber for alternatively providing at least two kinds of reactant gases into two vacuum processing chambers or two processing stations in one vacuum processing chamber; wherein, the gas supply device comprises:
a first gas source and a second gas source providing a first gas and a second gas, respectively;
a first gas switch, in which an input of the first gas switch is connected to the first gas source and an output of the first gas switch is switchably connected to gas inlets of the two vacuum processing chambers or the two processing stations respectively;
a second gas switch, in which an input of the second gas switch is connected to the second gas source and an output of the second gas switch is switchably connected to the gas inlets of the two vacuum processing chambers or the two processing stations respectively;
a control device for controlling the switching of the first gas switch and the second gas switch, so that when the first gas is connected to the gas inlet of one of the two vacuum processing chambers or one of the two processing stations and supplies the first gas through the gas inlet, the second gas is connected to the gas inlet of the other one of two vacuum processing chambers or the two processing stations, and supplies the second gas through the gas inlet.

2. The gas supply device for a vacuum processing chamber of claim 1, wherein, the first gas is etching reactant gas and the second gas is deposition reactant gas.

3. The gas supply device for a vacuum processing chamber of claim 2, wherein, the first gas includes SF₆ and O₂; the second gas includes C₄F₈, C₃F₆ and N₂.

4. The gas supply device for a vacuum processing chamber of claim 1, wherein, the switching time of switching the first gas switch and the second gas switch is less than 3 seconds.

5. The gas supply device for a vacuum processing chamber of claim 1, wherein, a first mass flow controller is connected between an output of the first gas source and the input of the first gas switch; and, a second mass flow controller is connected between an output of the second gas source and the input of the second gas switch.

6. The gas supply device for a vacuum processing chamber of claim 1, wherein, the gas supply device further comprises:
a first gas collection unit, in which an input of the first gas collection unit is connected to a first valve; the first valve is installed at the output of the first gas source; an output of the first gas collection unit is connected to the first gas source to gather the residual first gas and return it to the first gas source;
a second gas collection unit, in which an input of second gas collection unit is connected to a second valve; the second valve is installed at the output of the second gas source; an output of the second gas collection unit is connected to the second gas source to gather the residual second gas and return it to the second gas source.

7. The gas supply device for a vacuum processing chamber of claim 1, wherein, the gas supply device further includes a gas bypass which discharges the residual first gas or the residual second gas from vacuum processing chamber.

8. A vacuum processing chamber, wherein, the vacuum processing chamber includes the gas supply device of claim 1.

9. A gas supply and switching method for a vacuum processing chamber, which is used to alternatively provide at least two reactant gases for at least two vacuum processing chambers or two processing stations in one vacuum processing chamber, in which, the vacuum processing chamber includes the gas supply device of claim 1, wherein, the gas supply and switching method includes:
controlling the first gas switch to connect the first gas source with one of the two vacuum processing chambers or one of the two processing stations, the first gas source supplying the first gas for performing a first process;
controlling the second gas switch to connect the second gas source with the other one of two vacuum processing chambers or the other one of the two processing stations, the second gas source supplying the second gas for performing a second process;
controlling the control device to control the rapid switching between the first gas switch and the second gas switch, so that the first gas source and the second gas source exchange the connection with the respectively connected vacuum processing chamber or station;
repeating the above steps.

10. The gas supply and switching method for vacuum processing chamber of claim 9, wherein, the processing time performed in the two vacuum processing chambers or in the two processing stations are the same or substantially the same.

11. The gas supply and switching method for vacuum processing chamber of claim 9, wherein, the processing time performed in each of the vacuum processing chambers or each of the stations is different; and
reduce the output power of a radio-frequency power supply connected to the vacuum processing chamber or the station which has completed the process, keep supplying reactant gas to the vacuum processing chamber or the station, until the other vacuum processing chamber or the other station which has not finished the process completes the process;
when the process of all the vacuum processing chambers or the stations is finished, the first gas switch and the second gas switch are controlled to switch the connection of the reactant gas sources with the vacuum processing chambers or stations, and the output power of the radio-frequency power supply connected to all the vacuum processing chambers or the stations are returned to normal output level.

12. The gas supply and switching method for vacuum processing chamber of claim 9, wherein, the processing time performed in each of the vacuum processing chambers or each of the stations is different; and
provided that the processing time of one of the vacuum processing chambers or stations is shorter than that of other vacuum processing chambers or stations, slow down the reaction speed of the vacuum processing chamber or the station which has shorter processing time so that the whole processing time required in all vacuum processing chambers or all stations are the same or substantially the same.

13. The gas supply and switching method for vacuum processing chamber of claim 9, wherein, the processing time performed in each of the vacuum processing chambers or each of the stations is different; and
provided that the time required by the first process is longer than that of the second process, and when the second process is completed firstly, open the second valve, the second gas flows into the second gas collection unit and returns to the second gas source via the second gas collection; when the first process and the second process are both completed, close the second valve, and switch rapidly the first gas switch and the second gas switch so that the connection of the first gas source or the second gas source between the two vacuum processing chambers or the two processing stations is exchanged.
